(19) United States
(12) Patent Application Publication
(10) Pub. No.: US 2024/0183986 A1
(43) Pub. Date: Jun. 6, 2024

(54) TRAVELABLE AREA EXTRACTION APPARATUS, SYSTEM, AND METHOD, AND NON-TRANSITORY COMPUTER READABLE MEDIUM

(71) Applicant: NEC Corporation, Minato-ku, Tokyo (JP)

(72) Inventors: Akira Tsuji, Tokyo (JP); Jiro Abe, Tokyo (JP)

(73) Assignee: NEC Corporation, Minato-ku, Tokyo (JP)

(21) Appl. No.: 18/287,737

(22) PCT Filed: Apr. 26, 2021
(86) PCT No.: PCT/JP2021/016686

§ 371 Date: Oct. 20, 2023

(51) Int. Cl. G01S 17/89; B60W 60/00; G01S 17/08

(52) U.S. Cl. CPC G01S 17/89; B60W 60/00253; G01S 17/08; B60W 2300/10; B60W 2420/408; B60W 2552/53

(57) ABSTRACT

An object of the present disclosure is to provide a travelable area extraction apparatus and the like capable of extracting a travelable area from three-dimensional data. A disclosed travelable area extraction apparatus includes: a three-dimensional data input unit that inputs three-dimensional data from a three-dimensional data acquisition unit mounted in a vehicle; a position information acquisition unit that acquires position information of the vehicle; and a travelable area extraction unit that extracts a travelable area from the three-dimensional data on the basis of the position information of the vehicle and a road structure rule indicating a distance from one end to the other end of a traveling area in a road.

### TECHNICAL FIELD

The present disclosure relates to a travelable area extraction apparatus, a travelable area extraction system, a travelable area extraction method, and a non-transitory computer readable medium.

### BACKGROUND ART

A sensor such as Light Detection and Ranging (LiDAR) emits a laser to each measurement point of a measurement target, and can calculate a distance to each measurement point on the basis of a time from the emission of the laser to the reception of light. By using such a sensor while moving the sensor, it is possible to obtain the distance to the measurement target during traveling and the shape thereof. It is required to accurately extract a traveling area from point cloud data thus obtained.

For example, Patent Literature 1 discloses a travelable area detection apparatus capable of detecting a break of a road end in front of a moving body and determining whether or not there is a travelable area where the moving body can travel from the detected break of the road end. Further, Patent Literature 2 discloses a traveling road recognition apparatus that recognizes an end of a traveling road on which an own vehicle travels. The traveling road recognition apparatus includes a laser radar that emits a laser from the own vehicle toward the traveling road, a road surface determination unit that obtains a transverse gradient of the traveling road on the basis of a coordinate value of a point cloud obtained by the laser radar, and a road end determination unit that obtains a change point at which a gradient angle changes in the transverse gradient of the traveling road obtained by the road surface determination unit, and obtains a coordinate value of at least one of the ends of the traveling road on both sides in a transverse direction of the traveling road on the basis of a coordinate value of the change point.

### CITATION LIST

### Patent Literature

Patent Literature 1: International Patent Publication No. WO2018/123641
Patent Literature 2: Japanese Unexamined Patent Application Publication No. 2020-134367

### SUMMARY OF INVENTION

### Technical Problem

However, in various roads, it is difficult to detect road ends present on the road from captured images or point cloud data. There are various situations at both ends of the road, for example, a section where a guardrail exists, a section of a tunnel, a section where there is nothing, and the like, and the width of the point cloud of the road extracted on the point cloud data varies. Therefore, a travelable area extracted from the captured image or the point cloud data in which the section where the guardrail exists and the section where the guardrail does not exist are mixed may not be appropriate.

The present disclosure has been made to solve such a problem, and an object thereof is to provide a travelable area extraction apparatus, a travelable area extraction system, a travelable area extraction method, and a non-transitory computer readable medium capable of extracting a travelable area from three-dimensional data.

### Solution to Problem

A travelable area extraction apparatus according to a first aspect of the present disclosure includes: a three-dimensional data input unit that inputs three-dimensional data from a three-dimensional data acquisition unit mounted in a vehicle; a position information acquisition unit that acquires position information of the vehicle; and a travelable area extraction unit that extracts a travelable area from the three-dimensional data on the basis of the position information of the vehicle and a road structural rule indicating a distance from one end to the other end of a traveling area in a road.

A travelable area extraction system according to a second aspect of the present disclosure includes: a three-dimensional data acquisition unit that is mounted in a vehicle; a three-dimensional data input unit that inputs three-dimensional data from the three-dimensional data acquisition unit; a position information acquisition unit that acquires position information of the vehicle; and a travelable area extraction unit that extracts a travelable area from the three-dimensional data on the basis of the position information of the vehicle and a road structural rule indicating a distance from one end to the other end of a traveling area in a road.

A travelable area extraction method according to a third aspect of the present disclosure includes: inputting three-dimensional data from a three-dimensional data acquisition unit mounted in a vehicle; acquiring position information of the vehicle; and extracting a travelable area from the three-dimensional data on the basis of the position information of the vehicle and a road structural rule indicating a distance from one end to the other end of a traveling area in a road.

A non-transitory computer readable medium according to a fourth aspect of the present disclosure stores a program for causing a computer to execute: processing of inputting three-dimensional data from a three-dimensional data acquisition unit mounted in a vehicle; processing of acquiring position information of the vehicle; and processing of extracting a travelable area from the three-dimensional data on the basis of the position information of the vehicle and a road structural rule indicating a distance from one end to the other end of a traveling area in a road.

### Advantageous Effects of Invention

According to the present disclosure, it is possible to provide a travelable area extraction apparatus and the like capable of extracting a travelable area from three-dimensional data.

### BRIEF DESCRIPTION OF DRAWINGS

FIG. 1 is a block diagram illustrating a configuration of a travelable area extraction apparatus according to a first example embodiment.

FIG. 2 is an exemplary flowchart illustrating a travelable area extraction method according to the first example embodiment.

FIG. 3 is a diagram illustrating various sensors that can be mounted in a vehicle as viewed from the front in accordance with a second example embodiment.

FIG. 4 is a diagram illustrating various sensors that can be mounted in the vehicle as viewed from the rear in accordance with the second example embodiment.

FIG. 5 is a diagram illustrating an example of point cloud data acquired from the front of the vehicle.

FIG. 6 is a diagram illustrating an example of detecting a travelable area from a road.

FIG. 7 is a block diagram illustrating a configuration example of a travelable area extraction system.

FIG. 8 is a block diagram illustrating another configuration example of the travelable area extraction apparatus.

FIG. 9 is a diagram illustrating an example of detecting a travelable area from a curved road.

FIG. 10 is an exemplary flowchart illustrating a travelable area extraction method according to the second example embodiment.

FIG. 11 is a diagram illustrating an example of point cloud data acquired from the front of the vehicle.

FIG. 12 is a diagram illustrating an example of detecting a travelable area from a road.

FIG. 13 is a diagram illustrating an example of detecting a travelable area from a road.

FIG. 14 is a block diagram illustrating another configuration example of the travelable area extraction apparatus.

### EXAMPLE EMBODIMENT

Hereinafter, example embodiments of the present disclosure will be described in detail with reference to the drawings. In the drawings, the same or corresponding elements are denoted by the same reference numerals, and repeated description is omitted as necessary for clarity of description.

### First Example Embodiment

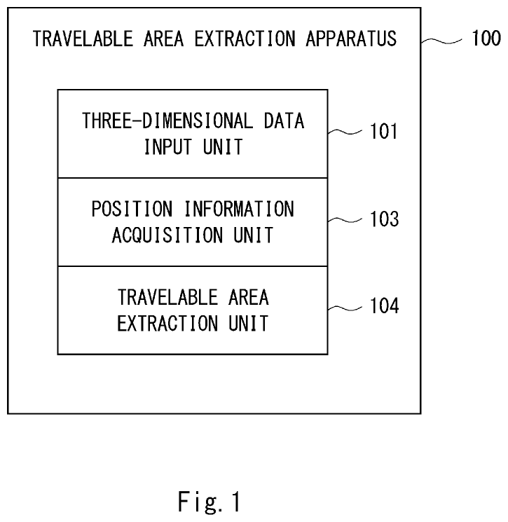

FIG. 1 is a block diagram illustrating a configuration of a travelable area extraction apparatus according to a first example embodiment.

A travelable area extraction apparatus 100 is implemented by a computer having a processor, a memory, and the like. The travelable area extraction apparatus 100 is mounted in a vehicle together with, for example, a three-dimensional data acquisition unit (for example, a LiDAR camera or the like), and can be used to extract a travelable area from three-dimensional data. Examples of the vehicle include a general vehicle, a bus, a truck, a two-wheeled vehicle, and any other suitable vehicle.

The travelable area extraction apparatus 100 includes a three-dimensional data input unit 101 that inputs three-dimensional data from a three-dimensional data acquisition unit mounted in a vehicle; a position information acquisition unit 103 that acquires position information of the vehicle; and a travelable area extraction unit 104 that extracts a travelable area from the three-dimensional data on the basis of the position information of the vehicle and a road structural rule indicating a distance from one end to the other end of a traveling area in a road.

The three-dimensional data input unit 101 is an input interface for inputting three-dimensional data from a three-dimensional data acquisition unit (for example, a LiDAR camera or the like). The three-dimensional data acquisition unit is fixed at a predetermined position of the vehicle, and its height (installation position) from the ground can be basically constant. The position information acquisition unit 103 may be various devices that acquire position information of the vehicle. For example, the position information acquisition unit 103 may be a magnetic sensor that detects a magnetic force of a magnetic marker laid on a road and recognizes a position of the vehicle, or may be a device (receiver) that detects a position of an own vehicle using a global navigation satellite system (GNSS) or a global positioning system (GPS). The position information acquisition unit 103 may be any other suitable device capable of acquiring accurate position information of the vehicle.

The road used in the present specification is a real road constructed according to the road structural rule. In addition, the traveling area used in the present specification is an area where the vehicle can travel, in the real road constructed according to the road structural rule. As described above, the position information acquisition unit 103 can specify the position of the vehicle traveling in the traveling area, thereby calculating respective distances from the current position of the vehicle to both ends of the traveling area constructed according to the rule. A width (that is, a distance from one end to the other end of the traveling area) and position information (for example, latitude and longitude, and the like) of the traveling area constructed according to the rule may be stored in a storage unit of the travelable area extraction apparatus 100 or an external storage unit connected to the travelable area extraction apparatus 100 in association with map information. The road structural rule is not necessarily defined by the state, the local public organization, or the like, and may be a road structural rule in a private land.

The travelable area extraction unit 104 extracts a travelable area corresponding to the traveling area in the three-dimensional data. At that time, since the installation position (for example, a laser emission position of the LiDAR sensor) of the three-dimensional data acquisition unit in the vehicle is fixed, the travelable area extraction unit 104 recognizes the position in the three-dimensional data corresponding to the installation position as the current position of the vehicle. Further, the travelable area extraction unit 104 extracts, as the travelable area, three-dimensional data corresponding to the distance from the current position of the vehicle to one end (that is, the road end) of the traveling area or the respective distances from the current position of the vehicle to both ends (both road ends) of the traveling area calculated as described above.

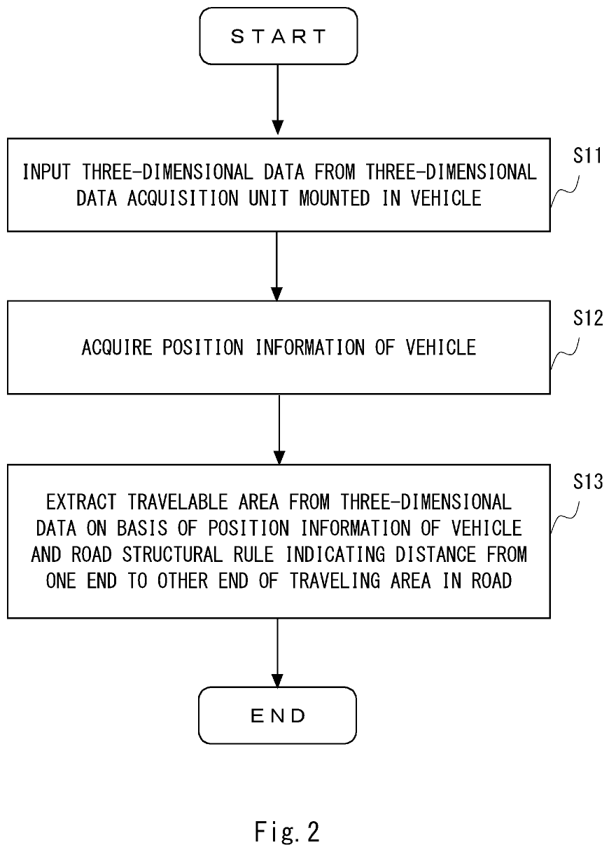

FIG. 2 is a flowchart illustrating a travelable area extraction method according to the first example embodiment.

The travelable area extraction method includes the following steps. The three-dimensional data input unit 101 inputs three-dimensional data from a three-dimensional data acquisition unit mounted in the vehicle (step S11). The position information acquisition unit 103 acquires position information of the vehicle (step S12). The travelable area extraction unit 104 extracts a travelable area from the three-dimensional data on the basis of the position information of the vehicle and the road structural rule indicating the distance from one end to the other end of the traveling area in the road (step S13).

The travelable area extraction apparatus and method according to the first example embodiment described above can appropriately extract the travelable area from the three-dimensional data without detecting the road end in the three-dimensional data.

### Second Example Embodiment

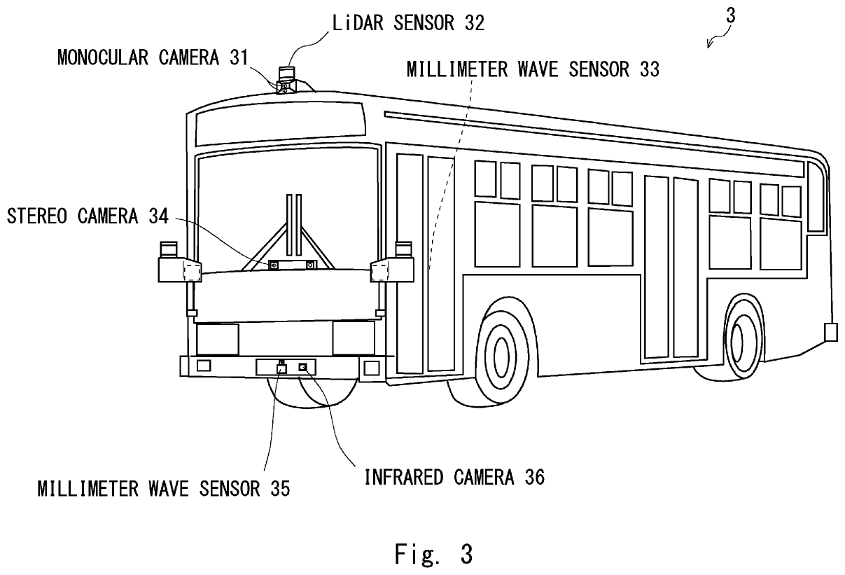

FIG. 3 is a diagram illustrating various sensors that can be mounted in a vehicle as viewed from the front in accordance with a second example embodiment.

A bus 3 that is an example of the vehicle includes a monocular camera 31 mounted on a front portion of the bus, a LiDAR sensor 32, a millimeter wave sensor 33 disposed near an opening/closing door of an entrance of the bus 3, a stereo camera 34 disposed near a front glass of the bus 3, a millimeter wave sensor 35 provided near a license plate in a front portion of the bus 3, and an infrared camera 36.

The monocular camera 31 can acquire a feature of a target by photographing the target with a single camera. The LiDAR sensor 32 identifies a distance to a target and a shape of the target by laser light. The LiDAR sensor 32 emits a laser to each measurement point of a measurement target, and can calculate a distance to each measurement point on the basis of a time from the emission of the laser to the reception of light. In some example embodiments, the LiDAR sensor 32 can acquire point cloud data of only the front of the bus 3. Further, in another example embodiment, the LiDAR sensor 32 is configured to be rotatable, and can acquire point cloud data from all directions so as to be able to detect an obstacle or the like at 360 degrees around.

The millimeter wave sensors 33 and 35 emit radio waves in a millimeter wave band, detect reflected waves, and acquire a distance to a target and a speed thereof. The stereo camera 34 is also called a front camera, and can record a distance to a target and a speed thereof by photographing the target with two cameras. The stereo camera 34 has an imaging element such as a charge coupled device (CCD) or a complementary metal oxide semiconductor (CMOS). The infrared camera 36 can visualize infrared rays emitted from a target.

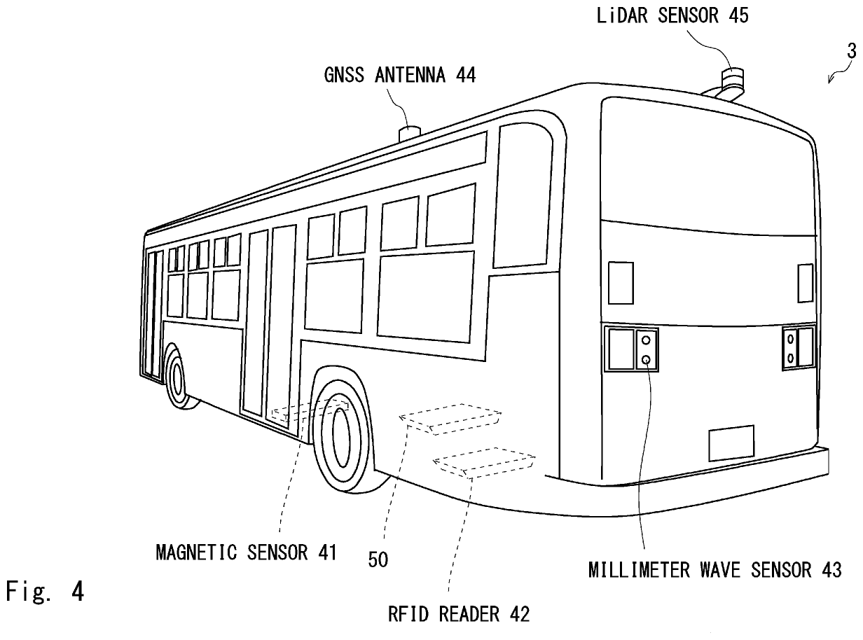

FIG. 4 is a diagram illustrating various sensors that can be mounted in the vehicle as viewed from the rear in accordance with the second example embodiment. The bus 3 includes a magnetic sensor 41 disposed on the lower side of the center of a vehicle body, an RFID reader 42 disposed on the lower side of the rear side of the vehicle body, a millimeter wave sensor 43, a global navigation satellite system (GNSS) antenna 44, and a LiDAR sensor 45.

The magnetic sensor 41 detects a magnetic force of a magnetic marker laid on a road, and acquires a position of a vehicle. The RFID reader 42 acquires RFID tag information attached to a partial magnetic marker laid on the road, and specifies the position of the vehicle. The millimeter wave sensor 43 emits radio waves in a millimeter wave band, detects reflected waves, and acquires a distance to a target and a speed thereof. The GNSS antenna 44 acquires radio waves of a positioning satellite in order to recognize the position of the vehicle. The LiDAR sensor 45 identifies a distance to a target and a shape of the target by laser light.

In some example embodiments, the LiDAR sensor 32 illustrated in FIG. 3 can acquire point cloud data of only the front of the bus 3. Further, in another example embodiment, the LiDAR sensor 32 is configured to be rotatable, and can acquire point cloud data from all directions so as to be able to detect an obstacle or the like at 360 degrees around. Further, in some example embodiments, the LiDAR sensor 45 illustrated in FIG. 4 can acquire point cloud data of only the rear of the bus 3. Further, in another example embodiment, the LiDAR sensor 45 is configured to be rotatable, and can acquire point cloud data from all directions so as to be able to detect an obstacle or the like at 360 degrees around.

These sensors attached to the bus 3 are merely examples, and some sensors may be omitted or added according to the example embodiment. These sensors and various devices such as an antenna and a reader can be connected to a traveling support control apparatus 50 via a network. The traveling support control apparatus 50 controls various control devices (not illustrated) mounted in the vehicle, controls the operation of the vehicle, and supports traveling. The various control devices may be, for example, an accelerator control unit, a brake control unit, a speaker control unit, a steering control unit, and the like.

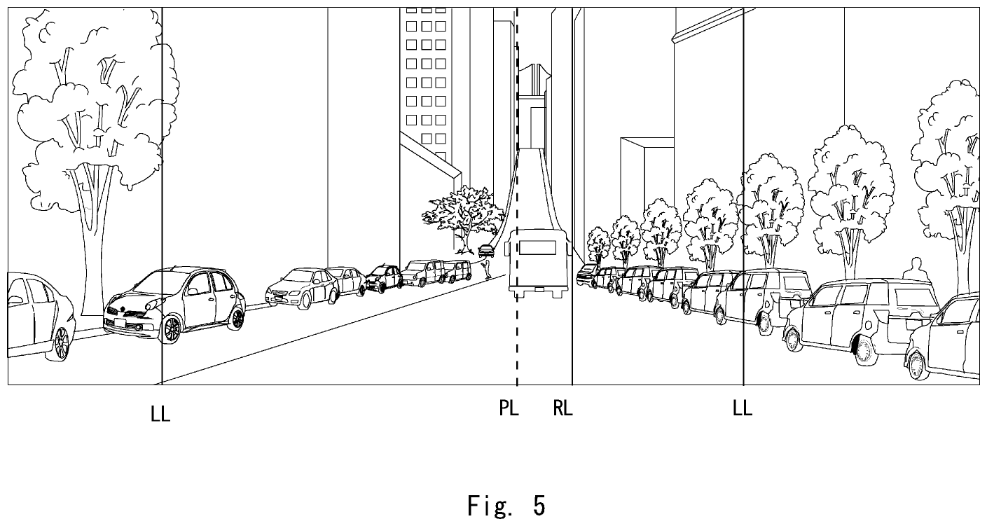

FIG. 5 is a diagram illustrating an example of point cloud data acquired from the front of the vehicle.

FIG. 5 illustrates an example of traveling on a straight road with one lane on each side. FIG. 5 illustrates point cloud data acquired by the LiDAR sensor 32 from only the target in front of the bus 3. As illustrated in FIG. 3, the LiDAR sensor 32 is disposed at a predetermined height in an upper portion of the front side of the bus 3. A current line PL schematically illustrates a line indicating a traveling direction from a position on the point cloud data corresponding to the installation position (for example, the laser emission position of LiDAR) of the LiDAR sensor 32.

In FIG. 5, it is difficult to accurately detect a road end from the point cloud data. For example, in FIG. 5, there are many vehicles parked on the road, and it is not possible to detect a target (for example, a guardrail or the like) that can be the road end. Therefore, the travelable area cannot be extracted from the point cloud data. Therefore, in the present example embodiment, first, an accurate position of the vehicle on the road is acquired, and a travelable area is extracted on the basis of position information and a road structural rule.

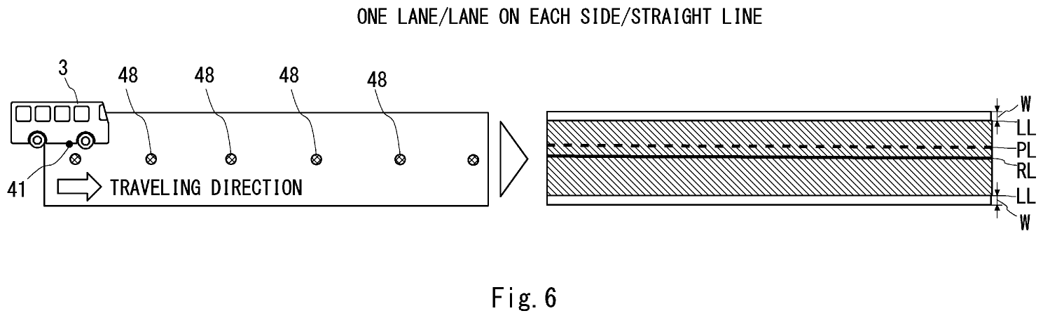

FIG. 6 is a diagram illustrating an example of detecting a travelable area.

FIG. 6 illustrates an example of traveling on a straight road with one lane on each side as illustrated in FIG. 5. It is assumed that the road used in the present specification is a road used for vehicle traffic, and also includes an area where the vehicle does not basically travel, such as a road shoulder. The traveling area used in the present specification refers to an area of the road where the vehicle can travel, which is defined according to the road structural rule. The travelable area used in the present specification refers to an area corresponding to the traveling area in the three-dimensional data (point cloud data) acquired by the sensor.

The bus 3 includes the magnetic sensor 41 as described above. The magnetic sensor 41 detects a magnetic force of a magnetic marker 48 laid on the road, and recognizes a position of the bus 3. A plurality of magnetic markers 48 can be laid on a traveling area (for example, a center line or the like) of the road at predetermined intervals. As a result, which position (for example, a point on a current line PL of a road width on the right side of FIG. 6) on the road the vehicle travels is determined with high accuracy. The traveling area (for example, an area indicated by hatching on the right side of FIG. 6) of the road is defined as a distance from a reference line RL (for example, a center line of the road) to a limit line LL which is an end of the traveling area in the road by the road structural rule, and the road is constructed according to this. Therefore, if an accurate current position of the vehicle is known, the distance from the current line PL to one limit line LL can also be calculated. The distance from the current line PL to the other limit line LL beyond the reference line RL can also be calculated. Note that, in the road structural rule, standard values of a roadway, a sidewalk, a road shoulder, a center strip, and the like for the width according to a road structure ordinance are defined. In the present example embodiment, a travelable area corresponding to the traveling area determined on the basis of the reference value of the width related to the roadway is extracted. Further, the reference line RL may be a line at the other end of the traveling area of the road (for example, in the case of one lane in FIG. 6). Further, the reference line RL may be a center line of the road (for example, in the case of two opposite lanes).

Here, returning to FIG. 5, the point cloud data corresponding to the distance from the current line PL to one limit line LL and the point cloud data corresponding to the distance from the current line PL to the other limit line LL are extracted as the travelable area. Therefore, in the present example embodiment, the travelable area can be extracted from the point cloud data without detecting the target (for example, the guardrail or the like) on the road end.

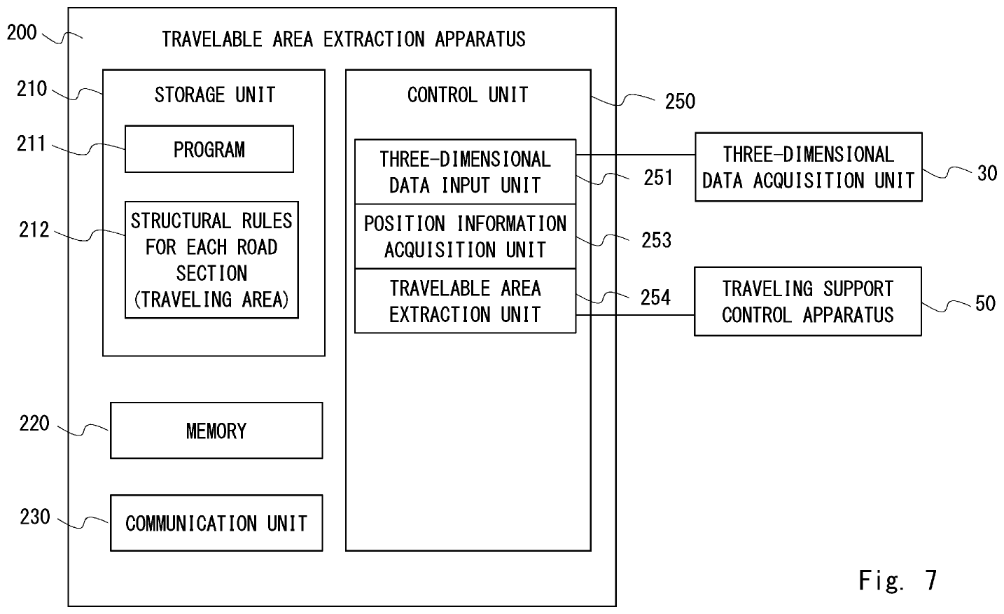

FIG. 7 is a block diagram illustrating a configuration example of a travelable area extraction system.

The travelable area extraction system includes a travelable area extraction apparatus 200, a three-dimensional data acquisition unit 30 mounted in the vehicle, and a traveling support control apparatus 50 that controls traveling of the vehicle.

The travelable area extraction apparatus 200 is implemented by a computer having a storage unit 210, a memory 220, a communication unit 230, a control unit 250, and the like. The control unit 250 includes a three-dimensional data input unit 251, a position information acquisition unit 253, and a travelable area extraction unit 254. The storage unit 210 includes a program 211 and a structural rule 212 for each road section. In the structural rule 212 for each road section, information (for example, a road width, a range of a traveling area, position information, and the like) regarding a traveling area for each road section is defined.

The three-dimensional data input unit 251 inputs three-dimensional data from a three-dimensional data acquisition unit 30 (for example, the LiDAR sensor 32) mounted in the vehicle. The three-dimensional data may be data (point cloud data or the like) on three orthogonal axes (that is, X, Y, and Z axes or axes such as a distance, an azimuth angle, and an elevation angle) for representing a road or the like on a digital space, acquired by a sensor such as LiDAR or a stereo camera. Since an attachment position of the three-dimensional data acquisition unit 30 (for example, the LiDAR sensor 32) is fixed, the position (PL in FIG. 5) in the three-dimensional data corresponding to the installation position of the three-dimensional data acquisition unit in the point cloud data illustrated in FIG. 5 is also fixed.

The position information acquisition unit 253 acquires position information of the vehicle. The position information acquisition unit 253 acquires the position of the vehicle on the road. As described above, the position information acquisition unit 253 can acquire highly accurate position information of the vehicle calculated by the magnetic sensor and the magnetic marker on the road. The magnetic marker may also be referred to as a position information provision unit. In the case of the RFID reader 42, the position information provision unit may be a partial magnetic marker laid on the road. The position information provision unit provides the RFID tag information attached to the magnetic marker to the position information acquisition unit 253, so that the position information acquisition unit 253 can specify the position of the vehicle. Further, in another example, the position information provision unit may be a beacon transmitter disposed on the road or in the vicinity thereof. Further, in another example embodiment, the position information acquisition unit 253 may acquire the position information of the vehicle from the GNSS antenna 44.

The travelable area extraction unit 254 extracts the travelable area from the three-dimensional data on the basis of the position information of the vehicle and the road structural rule indicating the distance from one end to the other end of the traveling area in the road. The road structural rule may be defined according to the road section (for example, defined from the first type to the fourth type, the type of road, the traffic capacity, the region, and the topography). That is, by using the structural rule of the road section associated with the current position information of the vehicle, information regarding the corresponding traveling area can be acquired from the current position of the vehicle. For example, when it is known from the current position of the vehicle that the vehicle travels on the third type of road, the distance from the reference position of the road to the limit position that is the end of the traveling area in the road can be obtained according to the structural rule of the third type of road. As a result, it is possible to extract a travelable area of the third type of road from the three-dimensional data.

The storage unit 210 is a storage device such as a hard disk or a flash memory. The storage unit 210 stores the structural rule 212 for each road section. Further, the storage unit 210 may store map information indicating a road network, a road section, a type of road (for example, a general road or an expressway), and the like.

The memory 220 is a volatile storage device such as a random access memory (RAM), and is a storage area for temporarily holding information during the operation of the control unit 250. The communication unit 230 is a communication interface with a network N. The communication unit 230 may be used to perform wireless communication. For example, the communication unit 230 may be used to perform wireless LAN communication defined in IEEE 802.11 series, or mobile communication defined in 3rd Generation Partnership Project (3GPP). Alternatively, the communication unit 230 may include, for example, a network interface card (NIC) conforming to IEEE 802.3 series.

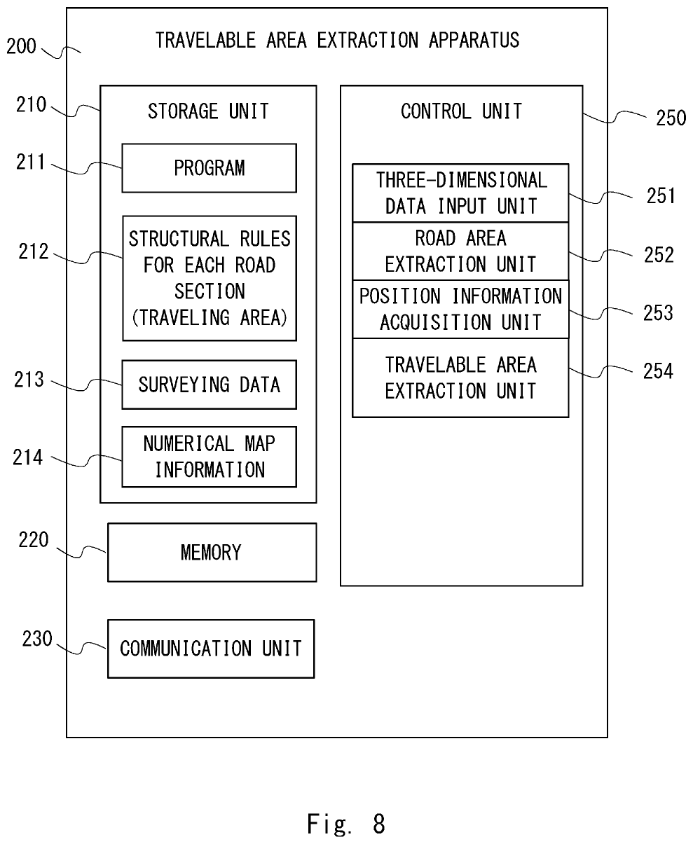

FIG. 8 is a block diagram illustrating another configuration example of the travelable area extraction apparatus 200.

In the present configuration example, a road area extraction unit 252 is added. In the input three-dimensional data, the road area extraction unit 252 extracts a specific range as a road area from a position in the three-dimensional data corresponding to the installation position of the three-dimensional data acquisition unit 30 (for example, the LiDAR sensor 32) mounted in the vehicle. Specifically, the road area extraction unit 252 extracts the road area from the input three-dimensional data on the basis of the traveling direction of the vehicle and the height from the installation position of the three-dimensional data acquisition unit to the road. The road area extraction unit 252 extracts, from the three-dimensional data (point cloud data), a road area where a road will exist below the installation position of the three-dimensional data acquisition unit by an amount corresponding to the height. Even when the LiDAR sensor 32 rotates around 360 degrees to acquire three-dimensional data, the road area extraction unit 252 can extract three-dimensional data in the traveling direction of the vehicle.

The travelable area extraction unit 254 extracts a travelable area from the extracted road area on the basis of the position information of the vehicle and the road structural rule associated with the position information of the vehicle. The traveling support control apparatus 50 controls traveling of the vehicle on the basis of the extracted travelable area.

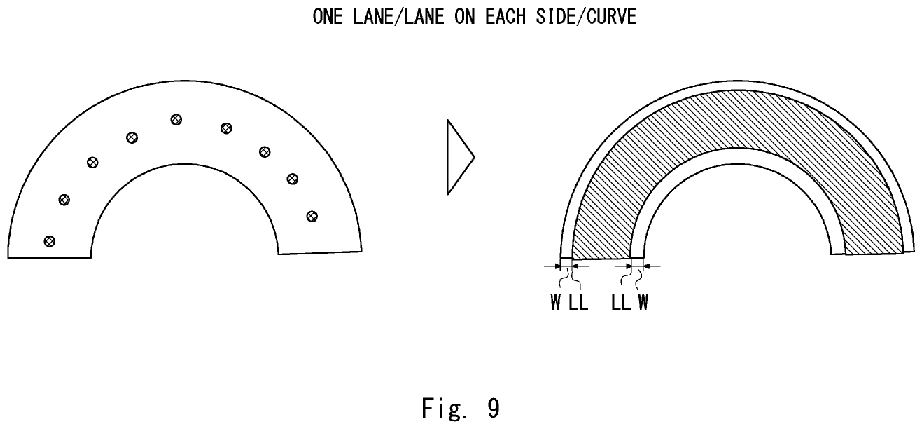

In the present configuration example, even when the vehicle does not travel in parallel to the road, the travelable area can be extracted. FIG. 9 illustrates an example of extraction of a traveling area on a curved road. On the basis of the installation position (height) of the vehicle of the three-dimensional data acquisition unit 30 (for example, the LiDAR sensor), the road area extraction unit 252 extracts three-dimensional data (point cloud data) of an area where a road will exist, and extracts, as a road area, an area where a normal vector is directed in a vertical direction with respect to the three-dimensional data. Even in a case of a sloping road, since the LiDAR is inclined according to the gradient of the sloping road when viewed from the world coordinate system, it is possible to extract a road area without the influence. The travelable area extraction unit 254 extracts a travelable area from the extracted road area on the basis of the position information of the vehicle and the road structural rule associated with the position information of the vehicle.

Alternatively, in another example embodiment, since surveying is performed when the road is constructed, the coordinates of the magnetic marker and surveying data are associated with each other in the world coordinate system, and it is determined which direction the road extends in according to the position of the vehicle, so that it is possible to cope with a case where the vehicle does not travel in parallel to the road. In this case, the surveying data is also provided as external information. The travelable area extraction apparatus 200 stores surveying data 213 in the storage unit 210. Further, numerical map information 214 owned by the Geospatial Information Authority of Japan may be used instead of the surveying data. The numerical map information 214 can also be stored in the storage unit 210. The travelable area extraction unit 254 extracts a travelable area from the extracted road area on the basis of the position information of the vehicle and the road structural rule, the surveying data, or the numerical map associated with the position information of the vehicle.

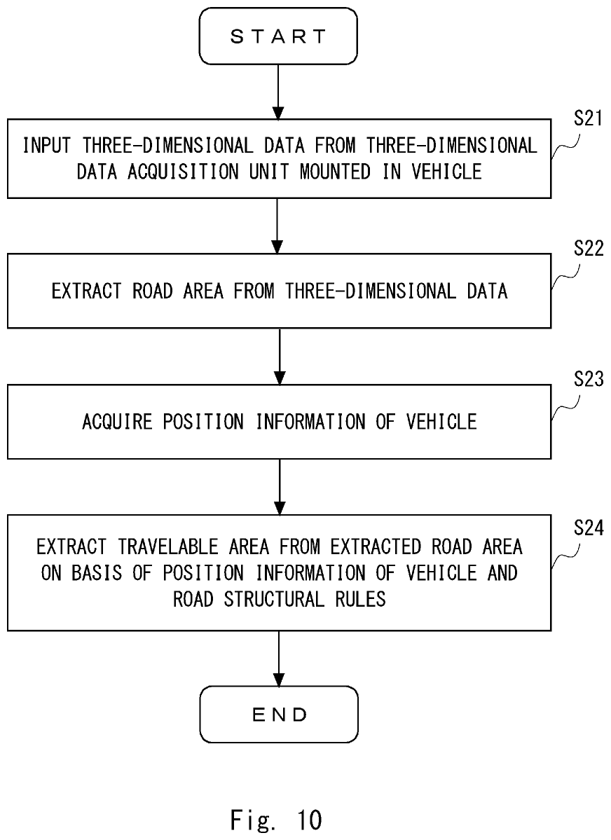

FIG. 10 is an exemplary flowchart illustrating a travelable area extraction method according to the second example embodiment.

The travelable area extraction method includes the following steps. The three-dimensional data input unit 251 inputs three-dimensional data from the three-dimensional data acquisition unit mounted in the vehicle (step S21). The road area extraction unit 252 extracts a specific range as a road area from a position in the three-dimensional data corresponding to the installation position of the three-dimensional data acquisition unit mounted in the vehicle (step S22). The road area extraction unit 252 extracts the road area from the input three-dimensional data on the basis of the traveling direction of the vehicle and the height from the installation position of the three-dimensional data acquisition unit 30 to the road. The position information acquisition unit 253 acquires position information of the vehicle (step S23). The travelable area extraction unit 254 extracts a travelable area from the extracted road area on the basis of the position information of the vehicle and the road structural rule indicating the distance from one end to the other end of the traveling area in the road (step S24).

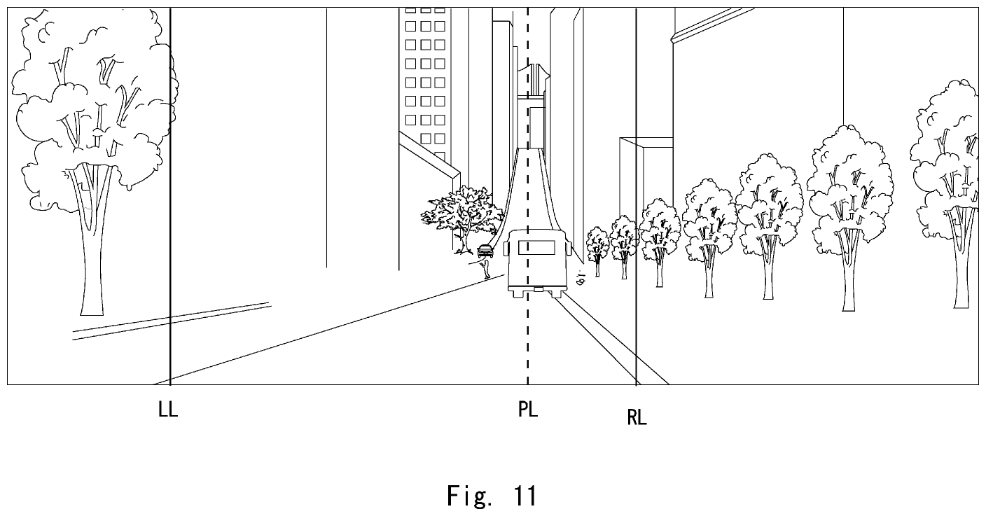

FIG. 11 is a diagram illustrating an example of point cloud data acquired from the front of the vehicle.

FIG. 11 illustrates an example of traveling on a straight road with two lanes on each side. FIG. 11 illustrates point cloud data acquired by the LiDAR sensor 32 from only a target in front of the bus 3. As illustrated in FIG. 3, the LiDAR sensor 32 is disposed at a predetermined height in an upper portion of the front side of the bus 3. A current line PL schematically illustrates a line indicating a traveling direction from a position in the point cloud data corresponding to the installation position (for example, the laser emission position of LiDAR) of the LiDAR sensor 32.

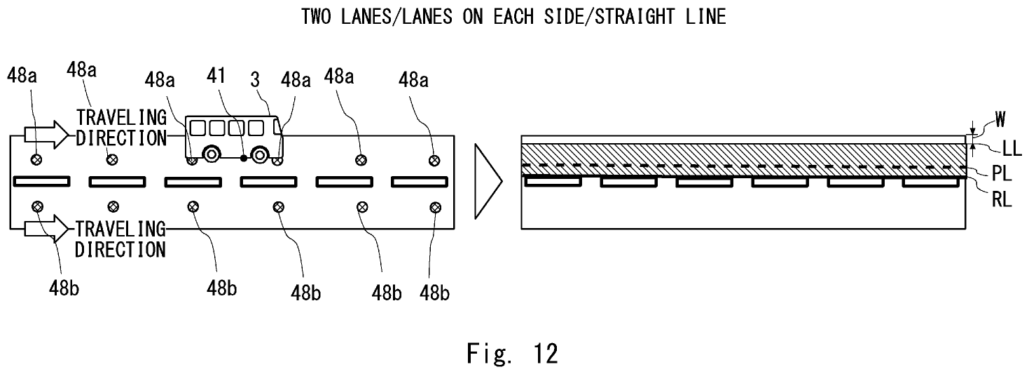

FIG. 12 is a diagram illustrating an example of detecting a travelable area.

FIG. 12 illustrates an example of traveling on a straight road with two lanes on each side as illustrated in FIG. 11. The bus 3 includes the magnetic sensor 41 as described above. The magnetic sensor 41 detects a magnetic force of a magnetic marker 48a laid on the traveling road, and recognizes a position of the bus 3. A plurality of magnetic markers 48a can be laid on a traveling area of the road at predetermined intervals. A plurality of magnetic markers 48b can also be laid at predetermined intervals in an adjacent traveling area. As a result, which position (for example, a point on the current line PL of the road width) on the road the vehicle travels is determined with high accuracy. The traveling area of the road is defined as a distance from the reference line RL (for example, a center line of the road or the like) to a limit line LL which is an end of the traveling area in the road by the road structural rule, and the road is constructed according to this. Therefore, if the accurate current position of the vehicle is known, a distance from the current line PL to the limit line LL can also be calculated. Further, a distance from the current line PL to the reference line RL can also be calculated.

Here, returning to FIG. 11, point cloud data corresponding to the distance from the current line PL to one limit line LL and point cloud data corresponding to the distance from the current line PL to the reference line RL are extracted as the travelable area. Therefore, in the present example embodiment, the travelable area can be extracted from the point cloud data without detecting the target (for example, the guardrail or the like) on the end.

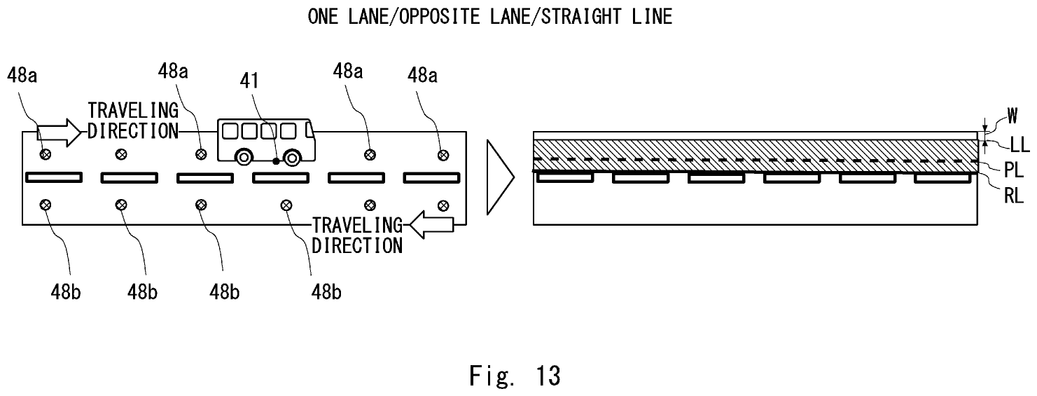

FIG. 13 is a diagram illustrating an example of detecting a travelable area.

FIG. 13 illustrates an example of traveling on a straight road with two lanes and one lane on each side. The bus 3 includes the magnetic sensor 41 as described above. The magnetic sensor 41 detects a magnetic force of a magnetic marker 48a laid on the road on which the vehicle is traveling, and recognizes a traveling lane and a position of the bus 3. A plurality of magnetic markers 48a can be laid on a traveling area of the road at predetermined intervals. A plurality of magnetic markers 48b can also be laid at predetermined intervals in an adjacent traveling area. As a result, which position (for example, a point on the current line PL of the road width) on the road the vehicle travels is determined with high accuracy. The traveling area of the road is defined as a distance from the reference line RL (for example, a center line of the road or the like) to a limit line LL which is an end of the traveling area in the road by the road structural rule, and the road is constructed according to this. Therefore, if the accurate current position of the vehicle is known, a distance from the current line PL to the limit line LL can also be calculated. Further, a distance from the current line PL to the reference line RL can also be calculated.

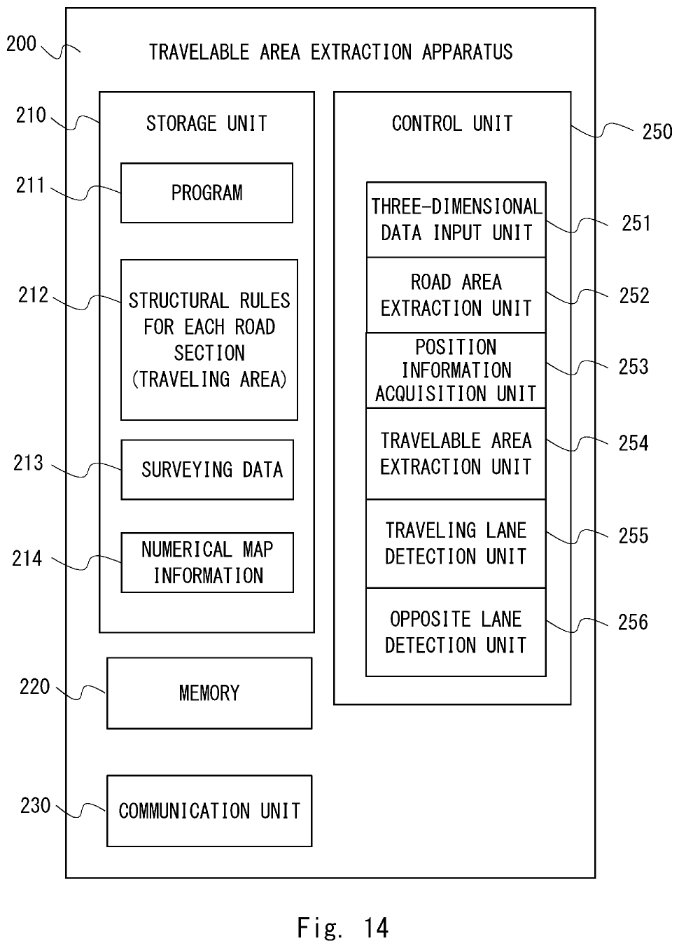

FIG. 14 is a block diagram illustrating another configuration example of the travelable area extraction apparatus 200.

In the present configuration example, a traveling lane detection unit 255 and an opposite lane detection unit 256 are supplementarily added. As described above, the traveling area associated with the current position of the vehicle is defined in advance according to the road structural rule. For this reason, if the current position of the vehicle is found, the traveling area corresponding thereto can be extracted. However, in order to more accurately determine the traveling area, in the present example embodiment, the traveling lane detection unit 255 and the opposite lane detection unit 256 are supplementarily added.

The traveling lane detection unit 255 detects a traveling lane on which the vehicle travels. For example, the traveling lane detection unit 255 may be the RFID reader 42. As illustrated in FIG. 12, in a case of acquiring the RFID tag information attached to the magnetic marker and acquiring the RFID tag information from the magnetic marker 48a, the traveling lane detection unit 255 can detect an area including the magnetic marker 48a as the traveling lane. Further, the opposite lane detection unit 256 detects an opposite lane on which an oncoming vehicle travels. For example, the opposite lane detection unit 256 may be the RFID reader 42. As illustrated in FIG. 13, in a case of acquiring the RFID tag information attached to the magnetic marker and acquiring the RFID tag information from the magnetic marker 48b, the opposite lane detection unit 256 can detect an area including the magnetic marker 48b as the opposite lane. The travelable area extraction unit 254 can extract the travelable area so as not to include the detected opposite lane.

Further, in another example embodiment, the traveling lane detection unit 255 may be the monocular camera 31 or the stereo camera 34. The traveling lane detection unit 255 can detect a line (for example, a solid line or a broken line of a white line, a solid line of a yellow line, or the like) on the road and recognize the traveling lane. The traveling lane detection unit 255 can detect the traveling lane by known image recognition technology. Further, the opposite lane detection unit 256 may be the monocular camera 31 or the stereo camera 34. In a case of detecting a white line, a median strip, or the like and further detecting an oncoming vehicle, a sign included in an opposite lane, or the like, the opposite lane detection unit 256 can detect the opposite lane of the road. The opposite lane detection unit 256 can detect the traveling lane by known image recognition technology. The travelable area extraction unit 254 can extract the travelable area so as not to include the detected opposite lane.

In still another example embodiment, the traveling lane detection unit 255 may be the LiDAR sensor 32. The traveling lane detection unit 255 can detect a line on the road (for example, a solid line or a broken line of a white line, a solid line of a yellow line, or the like) from a difference in laser reflection intensity between the asphalt and the lane, and recognize the traveling lane. The opposite lane detection unit 256 may be the LiDAR sensor 32. In a case of detecting a white line, a median strip, or the like and further detecting an oncoming vehicle, a sign included in an opposite lane, or the like, the opposite lane detection unit 256 can detect the opposite lane of the road.

The travelable area extraction unit 254 and the traveling lane detection unit 255 or the opposite lane detection unit 256 may be used in combination. For example, the travelable area may be extracted from the three-dimensional data by combining an area on the three-dimensional data corresponding to the distance from the current position (for example, the current line PL in FIG. 13) of the vehicle to the limit line (for example, LL in FIG. 13) of the traveling area which is the road end, and the traveling lane (for example, RL in FIG. 13) detected by the traveling lane detection unit 255 described above.

In addition, in the above-described example embodiments, the configuration of the hardware has been described, but the present disclosure is not limited thereto. According to the present disclosure, arbitrary processing can also be implemented by causing a CPU to execute a computer program.

In the above-described example, the program may be stored using various types of non-transitory computer readable media and supplied to a computer. The non-transitory computer readable media include various types of tangible storage media. Examples of the non-transitory computer readable media include a magnetic recording medium (for example, a flexible disk, a magnetic tape, or a hard disk drive), a magneto-optical recording medium (for example, a magneto-optical disc), a CD-read only memory (ROM), a CD-R, a CD-R/W, a digital versatile disc (DVD), and semiconductor memories (for example, a mask ROM, a programmable ROM (PROM), an erasable PROM (EPROM), a flash ROM, and a random access memory (RAM)). In addition, the program may be supplied to the computer by various types of transitory computer readable media. Examples of the transitory computer readable media include electrical signals, optical signals, and electromagnetic waves. The transitory computer readable media can supply programs to computers via wired or wireless communication paths, such as wires and optical fiber.

Note that the present disclosure is not limited to the above example embodiments, and can be appropriately changed without departing from the scope. Furthermore, the present disclosure may be implemented by appropriately combining the respective example embodiments.

The present invention has been described with reference to the example embodiments (and examples). However, the present invention is not limited to the above-described example embodiments (and examples). Various changes that can be understood by those skilled in the art can be made to the configurations and details of the present invention within the scope of the present invention.

Some or all of the above-described example embodiments may be described as in the following Supplementary Notes, but are not limited to the following Supplementary Notes.

### (Supplementary Note 1)

A travelable area extraction apparatus including:
a three-dimensional data input unit configured to input three-dimensional data from a three-dimensional data acquisition unit mounted in a vehicle;
a position information acquisition unit configured to acquire position information of the vehicle; and
a travelable area extraction unit configured to extract a travelable area from the three-dimensional data on the basis of the position information of the vehicle and a road structural rule indicating a distance from one end to the other end of a traveling area in a road.

### (Supplementary Note 2)

The travelable area extraction apparatus according to Supplementary Note 1, further including a road area extraction unit configured to extract a specific range as a road area from a position in three-dimensional data corresponding to an installation position of the three-dimensional data acquisition unit mounted in the vehicle in the input three-dimensional data,
wherein the travelable area extraction unit extracts a travelable area from the extracted road area on the basis of the position information of the vehicle and the road structural rule.

### (Supplementary Note 3)

The travelable area extraction apparatus according to Supplementary Note 1 or 2, wherein the road structural rule is defined for each road section, and is associated with the position information of the vehicle.

### (Supplementary Note 4)

The travelable area extraction apparatus according to Supplementary Note 2, wherein the road area extraction unit extracts the road area from the input three-dimensional data on the basis of a traveling direction of the vehicle and a height from the installation position of the three-dimensional data acquisition unit to the road.

### (Supplementary Note 5)

The travelable area extraction apparatus according to Supplementary Note 1, wherein the three-dimensional data acquisition unit acquires three-dimensional data for a traveling direction of the vehicle.

### (Supplementary Note 6)

The travelable area extraction apparatus according to Supplementary Note 1, wherein the three-dimensional data acquisition unit acquires three-dimensional data for all directions around the vehicle.

### (Supplementary Note 7)

The travelable area extraction apparatus according to any one of Supplementary Notes 1 to 6, wherein the position information acquisition unit acquires information from a position information provision unit installed on a road, and calculates position information of a vehicle on the road.

### (Supplementary Note 8)

The travelable area extraction apparatus according to any one of Supplementary Notes 1 to 7, further including:
a traveling lane detection unit configured to detect a traveling lane by detecting a line on a road on which a vehicle travels; and
an opposite lane detection unit configured to detect an opposite lane by detecting the line on the road and information indicating that the road is the opposite lane.

### (Supplementary Note 9)

A travelable area extraction system including:
a three-dimensional data acquisition unit mounted in a vehicle;
a three-dimensional data input unit configured to input three-dimensional data from the three-dimensional data acquisition unit;
a position information acquisition unit configured to acquire position information of the vehicle; and
a travelable area extraction unit configured to extract a travelable area from the three-dimensional data on the basis of the position information of the vehicle and a road structural rule indicating a distance from one end to the other end of a traveling area in a road.

### (Supplementary Note 10)

The travelable area extraction system according to Supplementary Note 9, further including a traveling support control apparatus configured to support traveling by controlling an operation of the vehicle, on the basis of the travelable area extracted from the three-dimensional data.

### (Supplementary Note 11)

The travelable area extraction system according to Supplementary Note 9 or 10, further including a position information provision unit installed on a road,
wherein the position information acquisition unit calculates a position of the vehicle by detecting information from the position information provision unit.

### (Supplementary Note 12)

A travelable area extraction method including:
inputting three-dimensional data from a three-dimensional data acquisition unit mounted in a vehicle;
acquiring position information of the vehicle; and
extracting a travelable area from the three-dimensional data on the basis of the position information of the vehicle and a road structural rule indicating a distance from one end to the other end of a traveling area in a road.

### (Supplementary Note 13)

A non-transitory computer readable medium storing a program for causing a computer to execute:
processing of inputting three-dimensional data from a three-dimensional data acquisition unit mounted in a vehicle;
processing of acquiring position information of the vehicle; and
processing of extracting a travelable area from the three-dimensional data on the basis of the position information of the vehicle and a road structural rule indicating a distance from one end to the other end of a traveling area in a road.

### REFERENCE SIGNS LIST

3 BUS
30 THREE-DIMENSIONAL DATA ACQUISITION UNIT
31 MONOCULAR CAMERA
32 LIDAR SENSOR
33 MILLIMETER WAVE SENSOR
34 STEREO CAMERA
35 MILLIMETER WAVE SENSOR
36 INFRARED CAMERA
41 MAGNETIC SENSOR
42 RFID READER
43 MILLIMETER WAVE SENSOR
44 GNSS ANTENNA
45 LIDAR SENSOR
50 TRAVELING SUPPORT CONTROL APPARATUS
100 TRAVELABLE AREA EXTRACTION APPARATUS
10 THREE-DIMENSIONAL DATA INPUT UNIT
103 POSITION INFORMATION ACQUISITION UNIT
104 TRAVELABLE AREA EXTRACTION UNIT
200 TRAVELABLE AREA EXTRACTION APPARATUS
210 STORAGE UNIT
211 PROGRAM
212 STRUCTURAL RULE FOR EACH SECTION OF ROAD
250 CONTROL UNIT
251 THREE-DIMENSIONAL DATA INPUT UNIT
252 ROAD AREA EXTRACTION UNIT
253 POSITION INFORMATION ACQUISITION UNIT
254 TRAVELABLE AREA EXTRACTION UNIT
255 TRAVELING LANE DETECTION UNIT
256 OPPOSITE LANE DETECTION UNIT

What is claimed is:

1. A travelable area extraction apparatus comprising:
at least one memory storing instructions, and
at least one processor configured to execute the instructions to;
input three-dimensional data from a three-dimensional data acquisition unit mounted in a vehicle;
acquire position information of the vehicle; and
extract a travelable area from the three-dimensional data on the basis of the position information of the vehicle and a road structural rule indicating a distance from one end to the other end of a traveling area in a road.

2. The travelable area extraction apparatus according to claim 1, wherein the at least one processor configured to execute the instructions to; extract a specific range as a road area from a position in three-dimensional data corresponding to an installation position of the three-dimensional data acquisition unit mounted in the vehicle in the input three-dimensional data, and
extract a travelable area from the extracted road area on the basis of the position information of the vehicle and the road structural rules.

3. The travelable area extraction apparatus according to claim 1, wherein the road structural rules are defined for each road section, and are associated with the position information of the vehicle.

4. The travelable area extraction apparatus according to claim 2, wherein the at least one processor configured to execute the instructions to; extract the road area from the input three-dimensional data on the basis of a traveling direction of the vehicle and a height from the installation position of the three-dimensional data acquisition unit to the road.

5. The travelable area extraction apparatus according to claim 1, wherein the at least one processor configured to execute the instructions to; acquire three-dimensional data for a traveling direction of the vehicle.

6. The travelable area extraction apparatus according to claim 1, wherein the at least one processor configured to execute the instructions to; acquire three-dimensional data for all directions around the vehicle.

7. The travelable area extraction apparatus according to claim 1, wherein the at least one processor configured to execute the instructions to; acquire information from a position information provision unit installed on a road, and calculate position information of a vehicle on the road.

8. The travelable area extraction apparatus according to claim 1, wherein the at least one processor configured to execute the instructions to;
detect a traveling lane by detecting a line on a road on which a vehicle travels; and
detect an opposite lane by detecting the line on the road and information indicating that the road is the opposite lane.

9. A travelable area extraction system comprising:
a three-dimensional data acquisition unit mounted in a vehicle;
at least one memory storing instructions, and
at least one processor configured to execute the instructions to;
input three-dimensional data from the three-dimensional data acquisition unit;
acquire position information of the vehicle; and
extract a travelable area from the three-dimensional data on the basis of the position information of the vehicle and a road structural rule indicating a distance from one end to the other end of a traveling area in a road.

10. The travelable area extraction system according to claim 9, further comprising a traveling support control apparatus configured to support traveling by controlling an operation of the vehicle, on the basis of the travelable area extracted from the three-dimensional data.

11. The travelable area extraction system according to claim 9, further comprising a position information provision unit installed on a road,
wherein the position information acquisition unit calculates a position of the vehicle by detecting information from the position information provision unit.

12. A travelable area extraction method comprising:
inputting three-dimensional data from a three-dimensional data acquisition unit mounted in a vehicle;
acquiring position information of the vehicle; and
extracting a travelable area from the three-dimensional data on the basis of the position information of the vehicle and a road structural rule indicating a distance from one end to the other end of a traveling area in a road.

13. A non-transitory computer readable medium storing a program for causing a computer to execute the method according to claim 12.
